(19) United States
(12) Patent Application Publication
(10) Pub. No.: US 2019/0390508 A1
(43) Pub. Date: Dec. 26, 2019

(54) DEVICE FOR CLOSING A ROOM OPENING AND METHOD FOR FITTING THE DEVICE

(71) Applicant: air-lux technik ag, Engelburg (CH)

(72) Inventor: Heinz SAUTER, St. Gallen (CH)

(21) Appl. No.: 16/445,398

(22) Filed: Jun. 19, 2019

(30) Foreign Application Priority Data
Jun. 21, 2018 (EP) 18178928.0

(51) Int. Cl. E06B 7/23; E06B 3/36

(52) U.S. Cl. CPC E06B 7/2318; E06B 3/36

(57) ABSTRACT

A device (1), for closing a room opening (2), comprising a frame (3) and a vertically pivoted casement or leaf (4) having at least one pivot point (5). The vertically pivoted casement or leaf (4) is fixed to the frame (3) at the pivot point so that the vertically pivoted casement or leaf (4) is rotatably relative to the frame (3) in the reveal (7) of the room opening (2). The device (1) comprises a first frame seal (8) to seal between the vertically pivoted casement or leaf (4) and the frame (3). The vertically pivoted casement or leaf (4) has an inside (9), an opposite outside (10) and an end face (11). In a closed position (40) of the vertically pivoted casement or leaf, the first frame seal (8) is arranged running around the end face of the vertically pivoted casement or leaf and is at least partially inflatable.

The present invention relates to a device for closing a room opening and a method for fitting the device according to the characterizing parts of the independent claims.

Devices for closing a room opening, such as windows or doors, are known in the prior art. The devices typically comprise a frame, on which a casement, or a leaf for example, is rotatably held. The casement or the leaf has an outside and inside. The devices moreover comprise an end face, in which elements such as a bolt and a lock are accommodated. A central aspect of such devices is the seal between the casement or the leaf and the frame. With the device closed, external influences such as wind and water should be unable to get in through the room opening. In the case of known seals for doors or windows a seal is adhesively bonded into the frame. Here the seal is applied on a mating surface of the frame to the inside or outside of the door in order to afford a tight seal.

One example of such a seal is shown in the utility model DE 202 18 443 U1. The sealing system for doors and windows comprises a frame seal fixed in a groove of a frame casing. The frame seal, at least in some areas, takes the form of a hose. The hose can be inflated by means of compressed air. The sealing system has the disadvantage that the doors can be opened only in one direction. Moreover, the sealing system is not suitable for vertically pivoted casements or for vertically pivoted leafs and the sealing effect is unsatisfactory.

EP 1 936 295 shows a sliding window. The sliding window can also be sealed by a hose-shaped sealing element between frame and sliding door. In contrast to DE 202 18 443 the seal is arranged on the sliding window itself. The seal is provided on an outside or an inside of the sliding window. Such a seal is not suitable for vertically pivoted casements or for vertically pivoted leafs.

The object of the invention, therefore, is to overcome the disadvantages of the prior art. In particular, the intention is to provide a device which has a good sealing effect and is suitable for pivoted door leafs or pivoted window casements. In particular, the device can be easily fitted.

This object is achieved by the device defined in the independent patent claims and by the method defined in the independent patent claims. Further embodiments emerge from the dependent patent claims.

A first aspect of the present invention relates to a device for closing a room opening. The device comprises a frame, which can be arranged in the room opening. The device moreover comprises a swivel window or a swivel door, in particular a pivoted casement or a pivoted leaf, having at least one pivot point. The pivoted casement or the pivoted leaf preferably has two pivot points. The pivoted casement is or the pivoted leaf fixed to the frame at the pivot point, so that the pivoted casement or the pivoted leaf is rotatably arranged in relation to the frame in the reveal of the room opening. The device comprises a first frame seal, in order to seal between the pivoted casement or the pivoted leaf and the frame. The pivoted casement or the pivoted leaf has an inside, an opposite outside and an end face. The device is characterized in that in a closed position of the pivoted casement or the pivoted leaf the first frame seal is arranged running around the end face of the pivoted casement or the pivoted leaf and is at least in part inflatable. In an alternative variant the frame seal may be arranged on a mating surface of the frame opposite the end face. In the alternative variant, too, the frame seal is inflatable. The mating surface is preferably parallel to the end face.

The frame seal is preferably arranged on the end face of the pivoted casement or the pivoted leaf. The seal is thereby better protected against dirt, damage and also water. In the inflated state, at least, the frame seal preferably protrudes from the rest of the end face. The end face preferably connects the inside and the outside. The end face may be at right-angles to the inside and the outside. Examples of room openings are window openings and in particular door openings. By using a pivoted casement or a pivoted leaf, wide room openings can be closed.

Here and in the following reference is made to the inside and the outside. The room opening is preferably an opening between an inside of a building, such as a house, for example, and an outside of the building. The device for closing a room opening described herein may also be used inside a building, however, in which case the terms inside and outside then relate to one of the two rooms and are interchangeable. The designations inside and outside are here intended to serve solely for the purposes of orientation and differentiation.

The room opening may be arranged in a house wall. The house wall may in particular be an outside wall of a building. In a variant the wall may also be an inside wall of a building.

In certain embodiments a facing may be applied to the inside and/or to the outside. Thus, for example, a timber cladding may be applied to the outside.

The frame can be fixed in the room opening. The frame may be inserted into the room opening on 3 sides, preferably on 4 sides (incl. the floor), of the reveal. The first pivot point is preferably arranged on a frame part on the lintel of the room opening or of the frame. The lintel is known to the person skilled in the art as an upper, preferably horizontal boundary of the room opening. The second pivot point is preferably arranged on a frame part on the lower boundary of the room opening.

In proper usage a swivel window or a swivel door has a vertical axis of rotation. A vertically pivoted casement or a vertically pivoted leaf turns about a perpendicular axis of rotation, in which case the axis of rotation may be arranged centrally or off-centre. The advantage of vertically pivoted casements or vertically pivoted leafs is that with the vertically pivoted casement or the vertically pivoted leaf open the casement or the leaf stands with less than the full width of the casement or the leaf in the room. If the axis of rotation is arranged in the centre, for example, the casement or the leaf stands with only half the width of the casement or the leaf in the room. The vertically pivoted casement or the vertically pivoted leaf may be transparent or at least comprise transparent areas. One example of this is a glass pane.

The vertically pivoted casement or the vertically pivoted leaf may be supported by a pivot bearing at the pivot point or pivot points. The pivot point may be arranged on the vertically pivoted casement or the vertically pivoted leaf at the top or bottom. Here and in the following, top and bottom are oriented according to gravity where the vertically pivoted casement or the vertically pivoted leaf is used in the correct way. The vertically pivoted casement or the vertically pivoted leaf preferably has two pivot points, for example one on an upper part of the end face and one on a lower part of the end face. This allows a precise perpendicular orientation of the vertically pivoted casement or the vertically pivoted leaf in the reveal of the room opening.

The frame seal may be hose-shaped. A cavity in the hose can be pumped up by a compressor, for example, so that the frame seal is inflated. The frame seal may be inflatable in part or in full, i.e., around the entire end face.

In one preferred embodiment the vertically pivoted casement or the vertically pivoted leaf can be rotated about the pivot point in a first direction from the closed position and in a second direction opposed to the first direction, so that the room opening can be opened. This makes use of the vertically pivoted casement or the vertically pivoted leaf more convenient. For example, it is thereby possible to open the vertically pivoted casement or the vertically pivoted leaf in the respective running direction when leaving the room and when entering the room.

In one preferred embodiment the pivot point is arranged on the end face and the first all-round frame seal is laterally offset in relation to the pivot point. This provides an uninterrupted frame seal without an inevitable leak at the site of the pivot point.

In one preferred embodiment the first frame seal is arranged in an all-round groove. This is a simple and stable way of holding the frame seal.

In one preferred embodiment the end face comprises a second, all-round frame seal laterally offset in relation to the first frame seal. The second frame seal serves to improve a sealing effect. The second frame seal also is preferably inflatable. The second frame seal may be inflatable around part or all of the end face.

In one preferred embodiment the first and the second frame seal lie on opposite sides of the pivot point on the end face. The pivot point at which a pivot bearing is preferably arranged is thereby protected in the closed state from environmental influences such as dust and water.

In one preferred embodiment a bearing of the pivot point comprises a hollow passage. Leads for security functions, such as locks and bolts, can be laid through the hollow passage. Means for actuating the inflatable frame seal could also run through the hollow passage.

In one preferred embodiment the vertically pivoted casement or the vertically pivoted leaf comprises a power supply. The power supply is preferably fed through the hollow passage and may be an electrical lead, especially a power supply lead. A compressed air line, may also be fed through the passage, however.

In one preferred embodiment the device comprises a first and/or a second mating surface opposite the frame seal. The first and/or the second mating surface protrudes from the rest of the frame or the rest of the end face in the direction of the first and/or the second frame seal. A sealing effect can thereby be achieved more rapidly when inflating the frame seal. Moreover, it can at the same time be ensured that the vertically pivoted casement or the vertically pivoted leaf can be opened without impinging or rubbing on the frame.

In one preferred embodiment the vertically pivoted casement or the vertically pivoted leaf comprises a compressor for inflating the first frame seal. In a further preferred embodiment the compressor has a suction function or the vertically pivoted casement or the vertically pivoted leaf comprises a separate suction device, in order to drain a pressure from the inflatable frame seal more rapidly. The vertically pivoted casement or the vertically pivoted leaf may more preferably comprise a second compressor for inflating the second frame seal.

The compressor is preferably fitted in a casement or a leaf profile of the vertically pivoted casement or the vertically pivoted leaf. The casement or the leaf profile preferably has a cavity. The compressor is preferably fitted in the cavity of the casement or the leaf profile. The compressor is thereby not externally visible. The device may comprise a compressor, which is connected to two or more frame seals via a “Y” piece, for example. The device may comprise a compressor for each frame seal. The compressor(s) may be connected to the frame seal(s) via a compressed-air line.

In one preferred embodiment the vertically pivoted casement or the vertically pivoted leaf comprises a trigger. The trigger is set up to activate the compressor (or compressors) via a compressor control, in order to inflate the frame seal. The trigger is preferably a pushbutton. In a variant the trigger may be integrated into a handle for opening the room opening.

In one preferred embodiment the end face has at least one rounded corner. All corners are preferably rounded. The radius of the roundings is preferably at least 5 mm. In especially preferred embodiments the radius is greater than 10 mm, 20 mm, or 30 mm. In one embodiment according to the invention the radius is approximately 50 mm. The first and/or the second frame seal can thereby be formed all round and can be inflated each at a single connection point.

A further aspect of the present invention relates to a method for fitting the vertically pivoted casement or the vertically pivoted leaf as described above with the frame as described above.

The invention is explained in more detail below, referring to figures, which only represent exemplary embodiments and which schematically show:

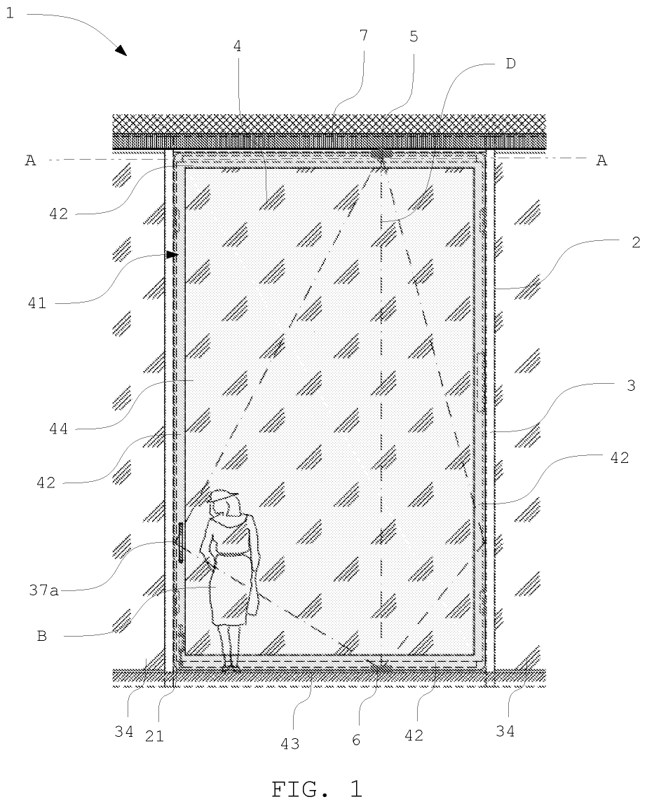

FIG. 1: a schematic representation of a device according to the invention with a frame and a vertically pivoted leaf from outside,

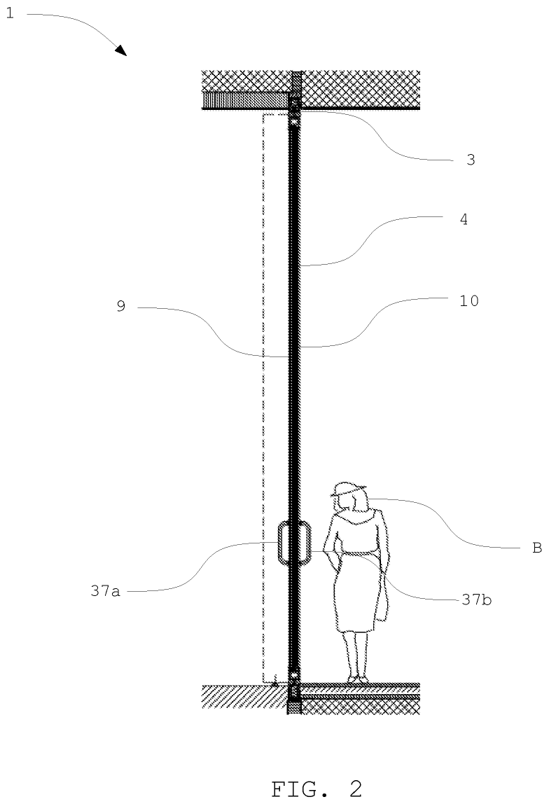

FIG. 2: a schematic representation of the device in FIG. 1 from the side,

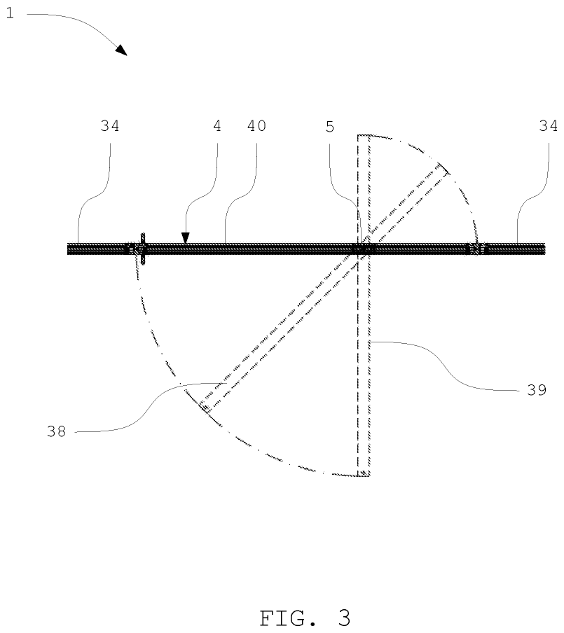

FIG. 3: a schematic representation of the device in FIG. 1 from above,

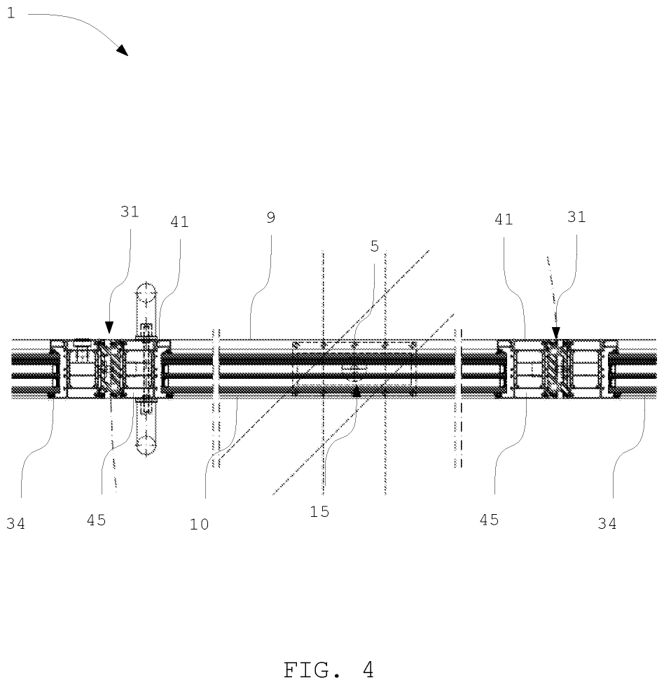

FIG. 4: a sectional view of the device in FIG. 1 along the axis A-A

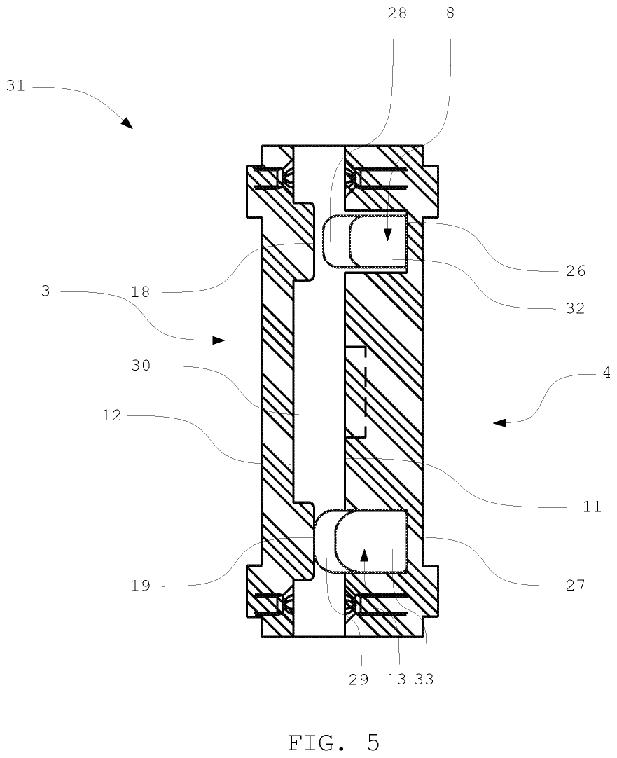

FIG. 5: a detailed view of a door gap of the device according to FIG. 1,

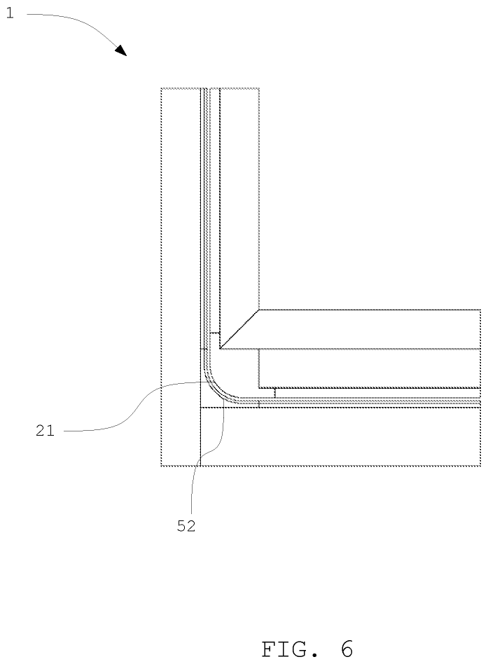

FIG. 6: a detailed view of a corner of the vertically pivoted leaf and of the frame from outside,

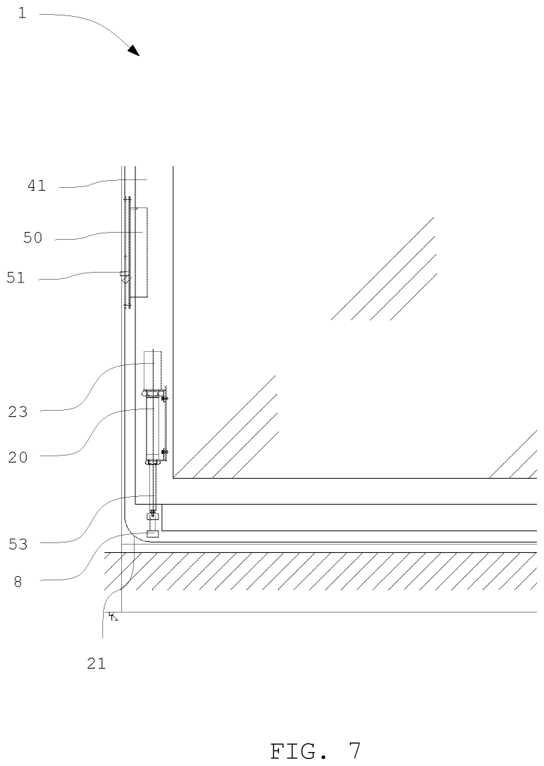

FIG. 7: a detailed view of the corner of the vertically pivoted leaf and of the frame in cross-section, and

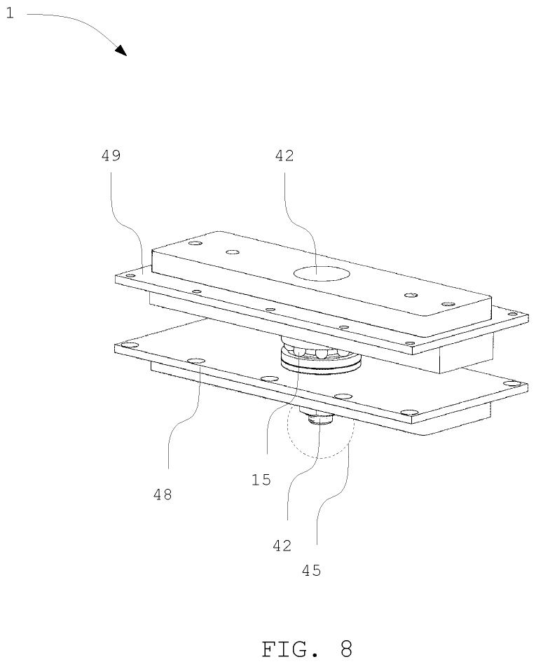

FIG. 8: a detailed view of a pivot bearing of a pivot point of the device according to FIG. 1.

FIG. 1 shows a device 1 for closing a room opening 2. The room opening 2 may be formed by masonry, which laterally defines the room opening 2. Alternatively, window panes 34 or panels, as shown in FIG. 1, may be arranged next to the device 1 and laterally define the room opening 2. At the bottom the room opening 2 is defined by the floor 43. An upper end of the room opening 2 is defined by a reveal 7. A frame 3 and a vertically pivoted leaf 4 are arranged in the room opening 2. The frame 3 is fixed to the reveal 3 and to the floor 43 and sealed in relation to the window panes 34. A non-transparent vertically pivoted leaf, as a panel with frame or of one-piece construction, is also feasible.

The vertically pivoted leaf 4 has multiple glazing, a leaf profile 41 receiving the glazing 44. The leaf profile 41 fully encloses the glazing 44. The leaf profile 41 here is assembled from multiple profile parts 42 and is formed from aluminium.

The vertically pivoted leaf 4 is held at the top at a first pivot point 5 on the reveal 7 and at the bottom at a second pivot point 6 on the floor 43. The vertically pivoted leaf 4 is rotatable about an axis of rotation D, which extends from the first pivot point 5 to the second pivot point 6. The vertically pivoted leaf 4 moreover comprises a handle 37a, by which a user B can open the vertically pivoted leaf 4. The vertically pivoted leaf 4 moreover has rounded corners 21 (see FIG. 6)

FIG. 2 shows a side view of the device 1 with the frame 3 and the vertically pivoted leaf 4. The user B can use the internal handle 37b to open the vertically pivoted leaf 4 outwards. The vertically pivoted leaf 4 can also be opened inwards, however, by the user B either pulling on the handle 37b or, if another user is entering from outside, by opening the door inwards using the external handle 37a.

A turning movement of the vertically pivoted leaf 4 is shown in detail in FIG. 3. A closed position 40 is shown in black in FIG. 3. In the closed position 40 the frame 3 and the vertically pivoted leaf 4 close the room opening 2. In turning about the axis of rotation D, the vertically pivoted leaf 4 can assume one of the positions 38 or 39 shown by dashed lines. The user B can then pass through the room opening 2. As shown in FIG. 1, the vertically pivoted leaf 4 is particularly suitable for large room openings 2, that is to say room openings 2 several times the size of a human body, for example. The vertically pivoted leaf 4 is glazed.

FIG. 4 shows a cross-section along the axis A-A (see FIG. 1). In a central part of the device 1 a bearing 15 (shown by dashed lines) is fitted to the pivot point 5.

An edge of the vertically pivoted leaf 4 is formed by the leaf profile 41. Here the leaf profile 41 forms a cavity 45, in which working parts can be arranged. For example, bolts 51 (see FIG. 7) for locking the vertically pivoted leaf 4 in the closed position 40 are arranged in the cavity 45. In addition, the cavity 45 has two compressors, which serve for inflating frame seals 8, 13 (see FIG. 5ff). The compressors and their possible positioning are described in EP 2 273 055.

A door gap 31, which is described in detail in FIG. 5, is located at the sides, adjoining the adjacent windows 34.

The door gap 31, as shown in FIG. 5, is formed by a distance 30 between an end face 11 of the vertically pivoted leaf 4 and an opposite mating surface 12 of the frame 3. The distance 30 between the frame 3 and the vertically pivoted leaf 4 allows the vertically pivoted leaf 4 to be opened by rotating it about the axis of rotation D. Due to the rotation, however, the gap 30 must be larger than in the case of sliding doors, in order that the vertically pivoted leaf 4 has sufficient space at the end face 11 for the rotation.

In order to seal the gap 30, the device 1 comprises a first and a second frame seal 8, 13. The first frame seal 8 is arranged in a first groove 26. The frame seal 8 is hose-shaped with a hollow part 32 and a sealing lip 28. The first frame seal 8 is shown in a deflated state, that is to say the vertically pivoted leaf 4 can be opened without the first frame seal 8 rubbing against the frame 3.

A first countersealing face 18 is arranged opposite the first frame seal 8. The countersealing face 18 protrudes from the rest of the frame 3, in particular the rest of the mating surface 12, in the direction of the end face 11. A distance in the gap between the frame seal 8 and the frame 3 is thereby reduced. Moreover, a central part is inset compared with the countersealing face 18, so that the vertically pivoted leaf 4 can still be easily opening without colliding.

In addition to the first frame seal 8, the vertically pivoted leaf 4 comprises a second frame seal 13. The second frame seal 13 is arranged in a second groove 27 and comprises a hose 33 and a sealing lip 29. The second frame seal 13 is shown in an inflated state. In the inflated state the sealing lip 29 is in contact with an opposite countersealing face 19. The pressure in the hose 33 presses the sealing lip 29 against the countersealing face 19 and thereby seals off the inside 9 from the outside 10.

FIG. 6 shows a corner 21 of the device 1 in detail. As can be seen from FIG. 6, the corner 21 is rounded. In the example shown the corner 21 has a rounding of approximately 50 mm (49.5 mm). Rounding the corner means that the hoses 32, 33 of the two frame seals 8, 13 are not kinked. A kink would prevent a uniform distribution of the air pressure in the hoses 32, 33 and would lead to the seal leaking, at least in parts. The frame 3 comprises a matching inverted rounding 52, so that the distance 30 remains constant.

The view in FIG. 7 shows a cross-section through the corner 21, so that the inside of the cavity 45 is visible. A first compressor 20 is arranged in the cavity 45. Through a line the first compressor 20 inflates the first frame seal 8. The compressor 20 has a compressor control 23, so that it can be activated by a pushbutton. A second compressor (not shown) of identical construction may be fitted elsewhere in the cavity 45. Alternatively, just one compressor 20 could be fitted and could be connected to both frame seals 8, 13 via a “Y” piece.

The pushbuttons (not shown) are arranged on the outside 9 and on the inside 10 below the handles 37a and 37b. When a user B operates the handle 37a or 37b, for example closes the doors, the compressor is simultaneously activated and the frame seals 8, 13 are inflated, so that the inside 10 is air and water-tight in relation to the outside 9.

FIG. 7 moreover shows a bolt 51 with a bolt mounting 50. The vertically pivoted leaf 4 can be securely locked by means of the bolt 51. Further bolts may be distributed along the end face 11.

The cavity 45 (see FIG. 4) also comprises electrical leads for supplying power to the compressor 20 auf. The electrical leads are introduced into the cavity 45 at the first pivot point 5. A bearing 15, which is arranged on an upper portion of the leaf profile 41 (opposite the reveal 7), encloses a hollow passage 42.

The passage 42 is shown in detail in FIG. 8. The bearing 15 itself is a ball bearing, which allows a rotation about the vertical axis of rotation D. The lower pivot point 6 also comprises a ball bearing.

One side of the ball bearing is connected to a first connecting plate 49. The connecting plate 49 can be bolted to the frame 3. The other side of the ball bearing is connected to a second connecting plate 48. The second connecting plate 48 can be bolted to the leaf profile 41.

A power lead, which serves to supply power to the compressor 20, is arranged in the hollow passage 42. Furthermore, actuators, for the bolt 50, for example, can likewise be supplied with power and control signals can be sent to the compressor 20 and/or to the bolt 51.

Conversely, information from sensors in the door could be retrieved via lines through the cavity 45 and in the leaf profile 41. Examples of such sensors are temperature sensors, humidity sensors or position sensors. Thus, it could be inquired via an electronic unit, for example, in what state the doors were (open or closed) and the doors closed and/or sealed.

The hollow passage 42 facilitates a power supply which is easy to maintain, since there are no batteries or accumulators that need replacing.

1. A device for closing a room opening, comprising
at least one frame, which can be arranged in the room opening,
at least one swivel window or swivel door having at least one pivot point, at which the swivel window or swivel door is fixed to the frame, so that the swivel window or swivel door is rotatably arranged in relation to the frame in the reveal of the room opening,
the device comprising at least a first frame seal, in order to seal between the swivel window or swivel door and the frame, and
the swivel window or swivel door having an inside, an opposite outside and an end face, and
wherein in a closed position of the swivel window or swivel door the first frame seal is arranged running around the end face of the swivel window, or swivel door or on a mating surface of the frame opposite the end face, and that the first frame seal is at least partially inflatable.

2. The device according to claim 1, wherein the swivel window or swivel door can be rotated about the pivot point in a first direction from the closed position and in a second direction opposed to the first direction, so that the room opening can be opened.

3. The device according to claim 1, wherein the pivot point is arranged on the end face and the first all-round frame seal is laterally offset in relation to the pivot point.

4. The device according to claim 1, wherein the first frame seal is arranged in an all-round groove.

5. The device according to claim 1, wherein the end face comprises a second all-round frame seal laterally offset in relation to the first frame seal.

6. The device according to claim 5, wherein the first and the second frame seals are arranged on opposite sides of the pivot point on the end face.

7. The device according to claim 1, wherein a bearing of the pivot point comprises a hollow passage.

8. The device according to claim 1, wherein the swivel window or swivel door comprises a power supply.

9. The device according to claim 1, wherein the device comprises at least one countersealing face opposite the frame seal, and at least a second countersealing face protruding from the rest of the frame or the rest of the end face in the direction of at least one frame seal.

10. The device according to claim 1, wherein the swivel window or swivel door comprises a first compressor for inflating the first frame seal.

11. The device according to claim 10, wherein the swivel window or swivel door comprises a trigger, and a compressor control, the trigger being set up to activate the first compressor via the compressor control in order to inflate the first frame seal.

12. The device according to claim 1, wherein the end face has at least one rounded corner, so that at least one of the frame seal can be inflated at a single connection point.

13. A method for fitting a swivel window or swivel door according to claim 1 in a room opening with a frame.

14. The device according to claim 1 wherein the swivel window or the swivel door is a pivoted casement or a pivoted leaf.

15. The device according to claim 1 wherein the swivel window or the swivel door is a vertically pivoted casement or a vertically pivoted leaf.

16. The device according to claim 1 wherein the swivel window or swivel door has two pivot points.

17. The device according to claim 7 wherein the swivel window or swivel door comprises of an electrical lead.

18. The device according to claim 7 wherein the power supply is fed through the hollow passage.

19. The device according to claim 8 wherein the power supply is fed through the hollow passage.

20. The device according to claim 1 wherein the swivel window or swivel door comprises a pushbutton.

21. The device according to claim 1 wherein the end face has four rounded corners.

22. The device according to claim 1 wherein the end face has at least one rounded corner with a radius of at least 5 mm.
